(19) United States
(12) Patent Application Publication
(10) Pub. No.: US 2013/0147538 A1
(43) Pub. Date: Jun. 13, 2013

(54) DIGITAL PRE-DISTORTION DEVICE AND PRE-DISTORTION METHOD THEREOF

(71) Applicants: Jung Hoon OH, Daejeon (KR); Joon Hyung KIM, Daejeon (KR); JAE HO JUNG, Daejeon (KR); HYUN KYU CHUNG, Daejeon (KR)

(72) Inventors: Jung Hoon OH, Daejeon (KR); Joon Hyung KIM, Daejeon (KR); JAE HO JUNG, Daejeon (KR); HYUN KYU CHUNG, Daejeon (KR)

(73) Assignee: Electronics and Telecommunications Research Institute, Daejeon (KR)

(21) Appl. No.: 13/560,040

(22) Filed: Jul. 27, 2012

(30) Foreign Application Priority Data
Dec. 7, 2011 (KR) 10-2011-0130319

(51) Int. Cl. G06F 7/48; G06F 7/556

(52) U.S. Cl. 327/346; 327/362; 327/350

(57) ABSTRACT

Disclosed is a digital pre-distortion device which includes a pre-compensation lookup table which outputs a first input value and a second input value adjacent to an input signal, a first distortion value corresponding to the first input value, and a second distortion value corresponding to the second input value; and a function generator which generates a pre-distortion function based on the first and second input values and the first and second distortion values and generates a pre-distortion value corresponding to the input signal from the pre-distortion function.

### CROSS-REFERENCE TO RELATED APPLICATIONS

A claim for priority under 35 U.S.C. §119 is made to Korean Patent Application No. 10-2011-0130319 filed Dec. 7, 2011, in the Korean Intellectual Property Office, the entire contents of which are hereby incorporated by reference.

### BACKGROUND

The inventive concepts described herein relate to a communication system, and more particularly, relate to a digital pre-distortion device and a method thereof.

In communication systems, a power of a transmission signal may be amplified in light of attenuation of a channel and easy reception at a receiving stage. A power of a transmission signal may be amplified by a power amplifier. The power amplifier may have non-linearity. It is necessary to sufficiently compensate for the non-linearity of the power amplifier for the high amplification efficiency. For example, the non-linearity of the power amplifier may be compensated through digital pre-distortion (DPD). With the digital pre-distortion, a signal provided to the power amplifier may be distorted in advance to compensate the non-linearity of the power amplifier. If the beforehand distorted signal is amplified by the power amplifier, a transmission signal may have a nearly linear response property.

Digital pre-distortion may be implemented in a lookup table manner in which a pre-distorted output value is provided according to amplitude of an input signal. A lookup table may include pre-distorted output values corresponding to discrete values of input signals, respectively. In the digital pre-distortion manner, the degree of accuracy (or, resolution) of a pre-distorted output value may become high by subdividing a level of an input signal. There may increase compensation efficiency on the non-linearity of a power amplifier according to an output value pre-distorted with the high degree of accuracy. However, if a size of a lookup table increases to provide the high linearity, there may increase a size of a memory and a time taken to update the lookup table.

### SUMMARY

One aspect of embodiments of the inventive concept is directed to provide a digital pre-distortion device comprising a pre-compensation lookup table which outputs a first input value and a second input value adjacent to an input signal, a first distortion value corresponding to the first input value, and a second distortion value corresponding to the second input value; and a function generator which generates a pre-distortion function based on the first and second input values and the first and second distortion values and generates a pre-distortion value corresponding to the input signal from the pre-distortion function.

Another aspect of embodiments of the inventive concept is directed to provide a digital pre-distortion method comprising judging whether an input value equal to a level of an input signal exists at a pre-compensation lookup table; when an input value equal to a level of an input signal does not exist at the pre-compensation lookup table, outputting a first input value and a second input value being approximate values of the input signal, a first distortion value corresponding to the first input value, and a second distortion value corresponding to the second input value; generating a pre-distortion function connecting a first coordinate point formed of the first input value and the first distortion value and a second coordinate point formed of the second input value and the second distortion value; and calculating a pre-distortion value corresponding to a level of the input signal on the pre-distortion function.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a transmitter using pre-distortion.

FIG. 2 is a block diagram illustrating a transmitter including a digital pre-distortion device according to an embodiment of the inventive concept.

FIG. 3 is a diagram for describing the effects of the inventive concept.

FIG. 4 is a diagram for describing an operation of a DPD processing unit in FIG. 2 according to an embodiment of the inventive concept.

FIG. 5 is a diagram for describing an operation of a DPD processing unit in FIG. 2 according to another embodiment of the inventive concept.

FIG. 6 is a graph illustrating a function of a function generator according to an embodiment of the inventive concept.

FIG. 7 is a flowchart illustrating a pre-distortion method according to an embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

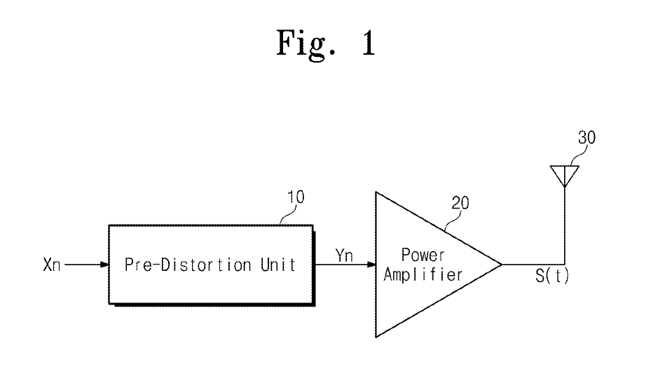

FIG. 1 is a block diagram schematically illustrating a transmitter using pre-distortion. Referring to FIG. 1, a transmitter may include a pre-distortion unit 110, a power amplifier 20, and an antenna 30.

The pre-distortion unit 110 may process an input signal Xn to provide a response characteristic corresponding to an inverse transfer function. That is, the pre-distortion unit 110 may process a signal to be distorted by the power amplifier 20 to a pre-distorted output signal Yn through multiplying with an inverse transfer function.

The power amplifier 20 may amplify the pre-distorted output signal Yn to transfer it to the antenna 30. A distortion characteristic of the power amplifier 20 may be reflected to the pre-distorted output signal Yn. As a result, an output signal S(t) of the power amplifier 20 may have the linearity with respect to the input signal Xn.

The pre-distortion unit 10 may provide a gain value for pre-distortion on the input signal Xn using a lookup table. It is possible to provide a gain value for pre-distortion on the input signal Xn in high speed. When a value exactly matched with a level of the input signal Xn, the pre-distortion unit 10 may calculate an optimum pre-distortion function corresponding to the input signal Xn to provide an exact pre-distortion characteristic.

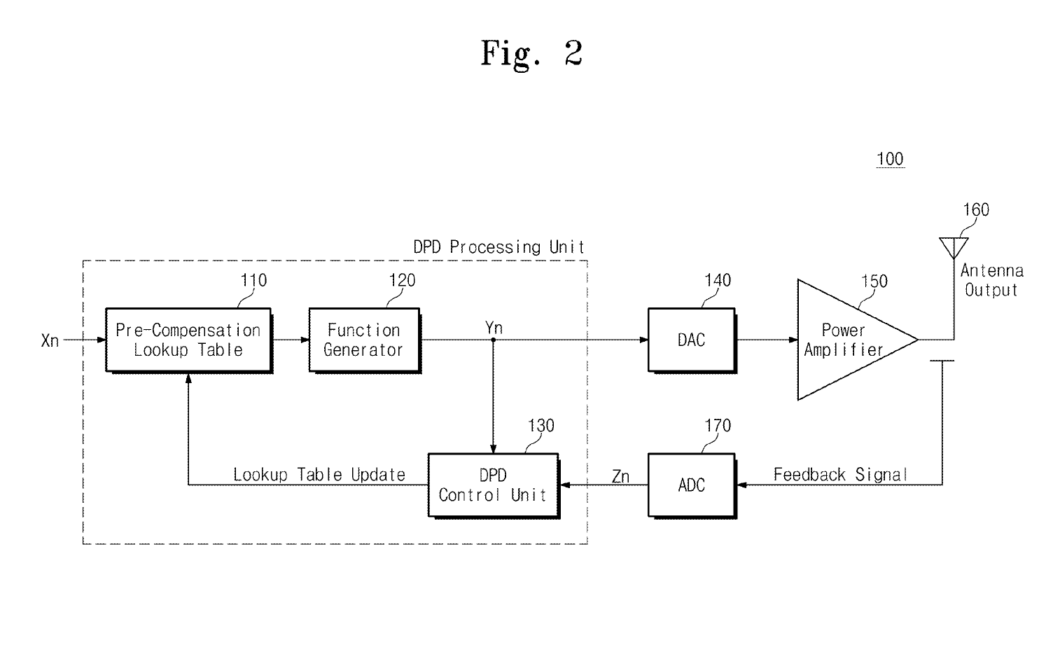

FIG. 2 is a block diagram illustrating a transmitter including a digital pre-distortion device according to an embodiment of the inventive concept. Referring to FIG. 2, a transmitter 100 of the inventive concept may include a pre-compensation lookup table 110, a function generator 120, a digital pre-distortion control unit 130, a digital-to-analog converter (hereinafter, referred to as DAC) 140, a power amplifier 150, an antenna 160, and a digital-to-analog converter (hereinafter, referred to as ADC) 170. Herein, the elements 110, 120, and 130 may constitute a digital pre-distortion (DPD) processing unit.

The pre-compensation lookup table 110 may provide an output value, to which an inverse function of a transfer characteristic of the power amplifier 140 is applied, according to a level of an input signal Xn. That is, the pre-compensation lookup table 110 may provide an output value which is obtained by discretely pre-distort the input signal Xn. The pre-compensation lookup table 110 may quantize a level of the input signal Xn to a discrete value. A pre-distortion value corresponding to a level of the input signal Xn detected as a discrete value may be transferred to the function generator 120. In the event that a level of a quantized input signal Xn is non-continuous, an error may be inevitably generated at a discrete process. For example, a memory having a huge capacity may be required when a lookup table is formed to include all pre-distortion values exactly corresponding to levels of input signals. Thus, an error may be inevitable because an approximated pre-distortion value is output with respect to an input signal Xn not existing at the lookup table.

The pre-compensation lookup table 110 may provide at least two input values Xi and Xi+1 approximate to an input signal Xn, which has a level not existing at the lookup table (or, memory), and pre-distortion values Yi and Yi+1 corresponding thereto. Herein, the input values Xi and Xi+1 may be approximate values of an input signal Xn that exists at the lookup table. In the event that an input level Xi (i=n) exactly matched with an input signal Xn exists, a corresponding pre-distortion value Yn to the input level Xi may be outputted. The pre-compensation lookup table 110 may be continuously updated by the DPD control unit 130.

The function generator 120 may provide a pre-distortion value Yn with the high degree of accuracy based on the pre-distortion value Yn or two input/output pairs (Xi, Yi) and (Xi+1, Yi+1) from the pre-compensation lookup table 110. If one pre-distortion value Yn is provided from the pre-compensation lookup table 110, mapping of the function generator 120 may be skipped, and the pre-distortion value Yn may be bypassed to the DAC 140. If two input/output pairs (Xi, Yi) and (Xi+1, Yi+1) are provided from the pre-compensation lookup table 110, the function generator 120 may generate a pre-distortion function of the power-amplifier 150 based on the o input/output pairs (Xi, Yi) and (Xi+1, Yi+1). The function generator 120 may map a precise pre-distortion value Yn on the input signal Xn based on the generated pre-distortion function.

The DPD control unit 130 may adaptively update the pre-compensation lookup table 110 based on a pre-distortion value Yn from the function generator 120 and a feedback signal Zn fed back from the power amplifier 150 through the ADC 170. Although not shown in figures, the feedback signal Zn may be attenuated at an output stage of the power amplifier 150 to be changed into a level capable of being processed by the DPD control unit 130. The pre-distortion value Yn may be delayed for synchronization with the feedback signal Zn. The DPD control unit 130 may compare the pre-distortion value Yn and the feedback signal Zn to detect an error continuously. The DPD control unit 130 may update the pre-compensation lookup table 110 such that errors to be detected decrease.

The DAC 140 may convert a pre-distortion value Yn on an input signal Xn output from the DPD processing unit 110, 120, and 130 into an analog signal. A pre-distortion value Yn converted into an analog signal may be up-converted into an RF band through various modulation manners. The up-converted pre-distortion value Yn may be provided to the power amplifier 150.

The power amplifier 150 may amplify a power of a signal provided from the DAC 140 to provide it to the antenna 160. The power amplifier 150 may amplify the up-converted signal to have such a level that it is wirelessly radiated through the antenna 160. The power amplifier 150 may be classified into various classes according to a linearity range of an output signal against an input signal. For example, the power amplifier 150 may be formed of a class-S power amplifier that receives attention as a next-generation mobile communication base state.

The ADC 170 may feed an output of the power amplifier 150 back to the DPD control unit 130. That is, for comparison with a pre-distortion value Yn, an output signal of the power amplifier 150 in an RF band may be processed by the ADC 170 and an attenuator (not shown). A feedback signal Zn converted into a digital signal by the ADC 170 may be provided to the DPD control unit 130.

With the transmitter including a pre-distortion processing unit of the inventive concept, the degree of accuracy of pre-distortion may be improved without additional hardware resources such as a memory resource. Thus, it is possible to improve the linearity of a signal output from the power amplifier 150 with respect to an input signal Xn.

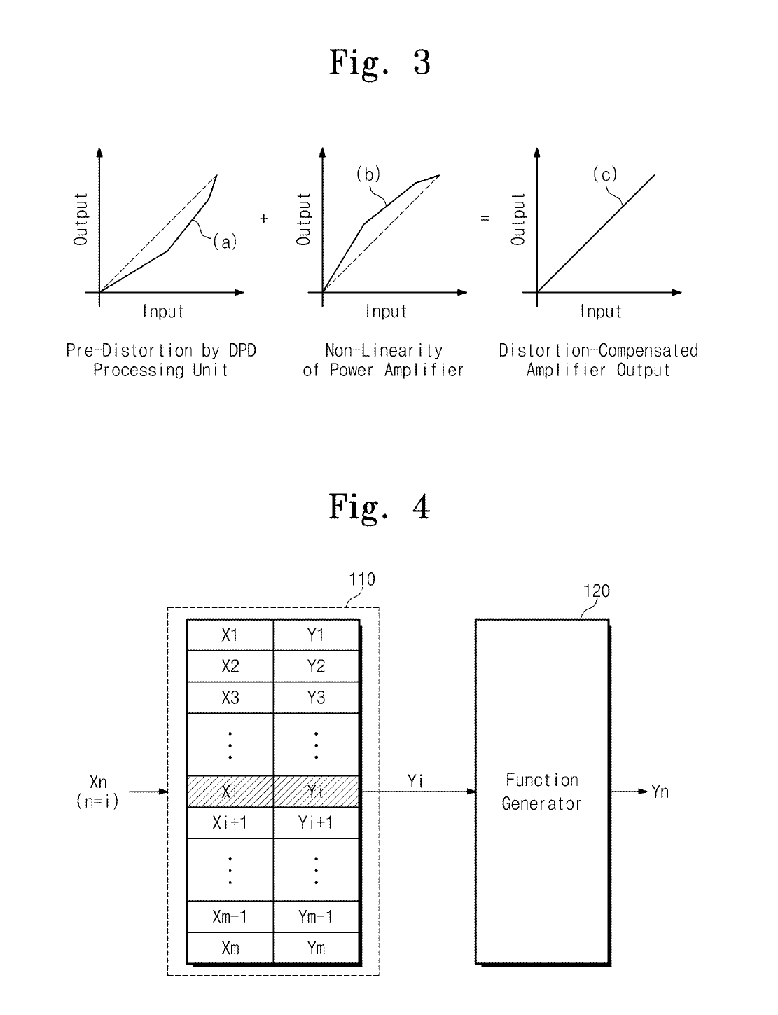

FIG. 3 is a diagram for describing the effects of the inventive concept. Referring to FIG. 3, transfer functions of components exemplarily shown at coordinate systems may be illustrated.

A graph (a) may illustrate a transfer function between an input signal and an output signal of a DPD processing unit 110, 120, and 130. That is, the graph (a) may show a transfer characteristic between an input signal Xn and a pre-distortion value Yn.

A graph (b) may illustrate a transfer characteristic between an input signal and an output signal of a power amplifier 150. In general, non-linearity of the power amplifier 150 may arise with respect to a level of an input signal or according to a frequency band. The graph (b) may show the non-linearity on a level of an input signal.

A graph (c) may illustrate an example that non-linearity of the power amplifier 150 is compensated by pre-distortion. The non-linearity which is inevitably generated by the power amplifier 150 may be improved by the pre-distortion. With pre-distortion executed by the DPD processing unit 110, 120, and 130, it is possible to provide a pre-distortion value Yn the error of which is minimized, without an increase in a size of a pre-compensation lookup table 110. As a result, it is possible to implement a transmitter 100 having the high linearity by a low cost.

FIG. 4 is a diagram for describing an operation of a DPD processing unit in FIG. 2 according to an embodiment of the inventive concept. Referring to FIG. 4, there may be illustrated an example that a list of a pre-compensation lookup table 110 includes a value coincident with a level of an input signal Xn.

The pre-compensation lookup table 110 may provide a pre-distortion value Yi for compensating a transfer characteristic of a power amplifier 150 according to a level an input signal Xn (n=i). That is, the pre-compensation lookup table 110 may map the input signal Xi onto a pre-distortion value Yi. With a manner where an output signal corresponding to an input signal is provided through a lookup table, a quantization error may be generated inevitably. On the other hand, when a table value Yi exactly matched with an input signal Xi exists, it is possible to provide a pre-distortion value Yi in high speed.

When provided with a table value Yi exactly matched with an input signal Xi from the pre-compensation lookup table 110, a function generator 120 may bypass the table value Yi without additional processing on a pre-distortion value Yn.

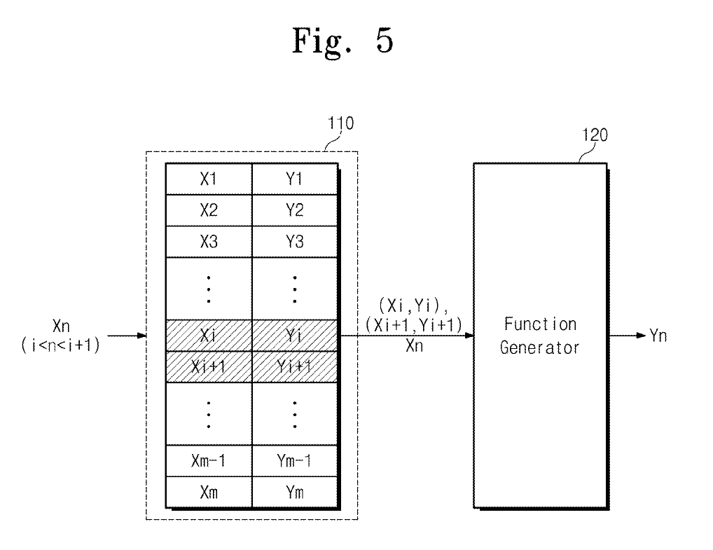

FIG. 5 is a diagram for describing an operation of a DPD processing unit in FIG. 2 according to another embodiment of the inventive concept. Referring to FIG. 5, there may be illustrated an example that a list of a pre-compensation lookup table 110 does not include a value coincident with a level of an input signal Xn.

The pre-compensation lookup table 110 may provide a pre-distortion value Yn for compensating non-linearity of a power amplifier 150 according to a level of an input signal Xn (i<n<i+1). In the event that a memory of the pre-compensation lookup table 110 is limited, it is impossible to provide all pre-distortion values each corresponding to input signals Xn through the pre-compensation lookup table 110. An approximate value of the pre-compensation lookup table 110 may be provided as a pre-distortion value Yn corresponding to an input signal Xn. In this case, however, a relatively large error may be generated at pre-distortion.

When a mapping value corresponding to an input signal Xn does not exist at the pre-compensation lookup table 110, the pre-compensation lookup table 110 of the inventive concept may provide a function generator 120 with at least two input/output pairs (Xi, Yi) and (Xi+1, Yi+1). The two input/output pairs (Xi, Yi) and (Xi+1, Yi+1) may have values, closest to the input signal Xn, from among values existing at the pre-compensation lookup table 110. For example, the input value Xi may be smaller than a level of an input signal Xn, and the input value Xi+1 may be larger than the level of the input signal Xn. The output values Yi and Yi+1 may be pre-distortion values mapped onto the input values Xi and Xi+1, respectively.

A function generator 120 may generate a gain function for compensating non-linearity of the power amplifier 150 in response to the two input/output pairs (Xi, Yi) and (Xi+1, Yi+1). The function generator 120 may generate a pre-distortion function considering the non-linearity of the power amplifier 150, based on the two input/output pairs (Xi, Yi) and (Xi+1, Yi+1). That is, the function generator 120 may generate a pre-distortion function connecting the input/output pairs (Xi, Yi) and (Xi+1, Yi+1) at the coordinate system. A shape of the pre-distortion function may reflect the non-linearity of the power amplifier 150.

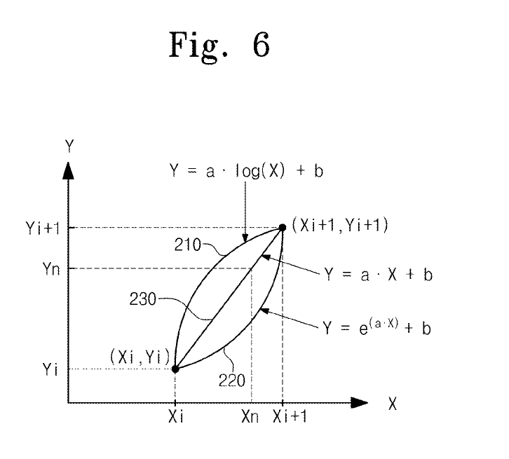

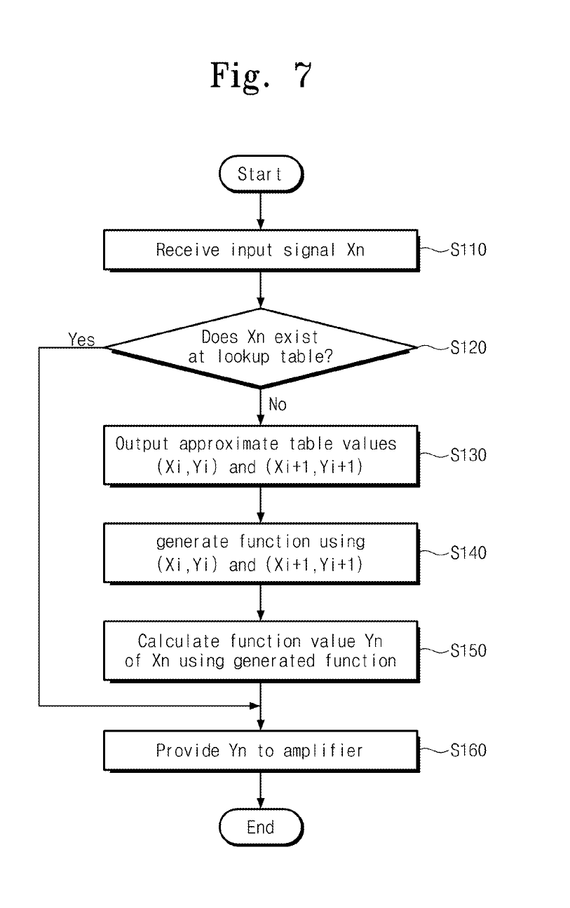

No data may exist between the input values Xi and Xi+1 on a lookup table. However, the pre-distortion function generated according to the two input/output pairs (Xi, Yi) and (Xi+1, Yi+1) may provide a pre-distortion value Yn as a continuous value on an input signal Xn existing between the input values Xi and Xi+1. Thus, it is possible to provide an error-minimized pre-distortion value Yn without sufficient securing of a memory size of the pre-compensation lookup table 110. Input/output characteristics of the function generator 120 will be more fully described with reference to FIG. 6.

With the pre-compensation lookup table 110 and the function generator 120, non-linearity of the power amplifier 150 may be compensated efficiently without an additional increase in a hardware resource such as a memory for forming a lookup table. Also, it is possible to reduce a memory size of the pre-compensation lookup table 110 and to shorten a time taken to update the pre-compensation lookup table 110.

FIG. 6 is a graph illustrating a function of a function generator according to an embodiment of the inventive concept. Referring to FIG. 6, when two input/output pairs (Xi, Yi) and (Xi+1, Yi+1) are provided from a pre-compensation lookup table 110, a function generator 120 may make a pre-distortion function f(X).

The function generator 120 may receive an input signal Xn and the input/output pairs (Xi, Yi) and (Xi+1, Yi+1) from the pre-compensation lookup table 110. The function generator 120 may generate a function of connecting coordinate points on a coordinate formed by the input/output pairs (Xi, Yi) and (Xi+1, Yi+1). The function generator 120 may generate a function connecting the input/output pairs (Xi, Yi) and (Xi+1, Yi+1) on the coordinate.

For example, the function generator 120 may generate a linear function for connecting coordinates (Xi, Yi) and (Xi+1, Yi+1). A pre-distortion function f(X) on the coordinate system may be Y=aX+b. A slope a and a Y-intersect b may be obtained by substituting the coordinates (Xi, Yi) and (Xi+1, Yi+1) into the function f(X). The linear function f(X) may be marked by a reference numeral 230.

In other example embodiments, the function generator 120 may generate a log function for connecting coordinates (Xi, Yi) and (Xi+1, Yi+1). A pre-distortion function f(X) on the coordinate system may be Y=a·log(X)+b. Variables a and b may be obtaining by substituting the coordinates (Xi, Yi) and (Xi+1, Yi+1) into the function f(X). The log function f(X) may be marked by a reference numeral 210.

In still other example embodiments, the function generator 120 may generate an exponential function for connecting coordinates (Xi, Yi) and (Xi+1, Yi+1). A pre-distortion function f(X) on the coordinate system may be Y=e^{(a·X)}+b. Variables a and b may be obtaining by substituting the coordinates (Xi, Yi) and (Xi+1, Yi+1) into the function f(X). The exponential function f(X) may be marked by a reference numeral 220.

Pre-distortion functions capable of being selected by the function generator 120 may be changed variously. The above-describe pre-distortion function may be made in light of a transfer function of the power amplifier 150 to compensate for non-linearity of the power amplifier more efficiently.

FIG. 7 is a flowchart illustrating a pre-distortion method according to an embodiment of the inventive concept. With the inventive concept, a pre-distortion value with the high degree of accuracy may be provided by a pre-compensation lookup table 110 and a function generator 120. This will be more fully described below.

In operation S110, a pre-compensation lookup table 110 may receive an input signal Xn. Although not shown in figures, a signal being a continuous wave analog signal may be provided as a discrete input signal Xn through sampling or quantizing.

In operation S120, whether an input value Xi corresponding to the input signal Xn exists at the pre-compensation lookup table 110 may be judged. The input signal Xn may have a value obtained by quantizing the amplitude of a continuous wave. Thus, a value matched with the input signal Xn cannot exist at a list of the pre-compensation lookup table 110 being a mapping table of discrete input values. If an input value Xi corresponding to the input signal Xn does not exist at the pre-compensation lookup table 110, the method proceeds to operation S130, in which at least two input/output pairs (Xi, Yi) and (Xi+1, Yi+1) are provided to a function generator 120. On the other hand, if an input value Xi corresponding to the input signal Xn exists at the pre-compensation lookup table 110, the method proceeds to operation S160, in which a pre-distortion value Yn matched with the input signal Xn is output.

In operation S130, the pre-compensation lookup table 110 may provide the function generator 120 with at least two input/output pairs (Xi, Yi) and (Xi+1, Yi+1). Herein, the two input/output pairs (Xi, Yi) and (Xi+1, Yi+1) may have values, closest to the input signal Xn, from among values existing at the pre-compensation lookup table 110. For example, the input value Xi may be smaller than a level of an input signal Xn, and the input value Xi+1 may be larger than the level of the input signal Xn. The output values Yi and Yi+1 may be pre-distortion values mapped onto the input values Xi and Xi+1, respectively.

In operation S140, the function generator 120 may generate a function based on the at least two input/output pairs (Xi, Yi) and (Xi+1, Yi+1). The function generator 120 may generate a function for connecting coordinates formed of the at least two input/output pairs (Xi, Yi) and (Xi+1, Yi+1). Herein, the function may include a linear function, a log function, an exponential function, and the like.

In operation S150, the function generator 120 may obtain a pre-distortion value Yn, which does not exist at the pre-compensation lookup table 110, from two coordinate points corresponding to the two input/output pairs (Xi, Yi) and (Xi+1, Yi+1). Thus, the function generator 120 may provide a pre-distortion value which is not provided by the pre-compensation lookup table 110.

In operation S160, a pre-distortion value Yn corresponding to the input signal Xn output from the function generator 120 may be provided to a power amplifier 150 through a DAC 140. A power of the pre-distorted signal Yn may be amplified by the power amplifier 150. The signal Yn power-amplified by the power amplifier 150 may be output as such a value that the non-linearity of the power amplifier 150 is compensated.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A digital pre-distortion device comprising:
a pre-compensation lookup table which outputs a first input value and a second input value adjacent to an input signal, a first distortion value corresponding to the first input value, and a second distortion value corresponding to the second input value; and
a function generator which generates a pre-distortion function based on the first and second input values and the first and second distortion values and generates a pre-distortion value corresponding to the input signal from the pre-distortion function.

2. The digital pre-distortion device of claim 1, wherein the pre-compensation lookup table is formed of a mapping table of an input value corresponding to a level of an input signal and a pre-distortion value on the input value, and
wherein when an input value coincident with a level of the input signal does not exist, the pre-compensation lookup table outputs the first input value, the first distortion value, the second input value, and the second distortion value.

3. The digital pre-distortion device of claim 2, wherein when an input value coincident with a level of the input signal exists, the pre-compensation lookup table outputs a distortion value mapped onto the input value as the pre-distortion value.

4. The digital pre-distortion device of claim 3, wherein an input value coincident with a level of the input signal exists, the function generator bypasses the pre-distortion value to the power amplifier.

5. The digital pre-distortion device of claim 1, wherein the function generator generates the pre-distortion function connecting a first coordinate point formed of the first input value and the first distortion value and a second coordinate point formed of the second input value and the second distortion value.

6. The digital pre-distortion device of claim 5, wherein the pre-distortion function is at least one of a linear function, a log function, or an exponential function connecting the first coordinate point and the second coordinate point.

7. The digital pre-distortion device of claim 5, wherein the function generator generates the pre-distortion function based on non-linearity of the power amplifier.

8. The digital pre-distortion device of claim 1, further comprising:
a digital pre-distortion control unit which compares the pre-distortion value with a feedback signal of the power amplifier on the pre-distortion value to update the pre-compensation lookup table.

9. The digital pre-distortion device of claim 8, wherein the digital pre-distortion control unit updates the pre-compensation lookup table with a value which exists between the pre-distortion value and the feedback signal and decreases an error.

10. A digital pre-distortion method comprising:
judging whether an input value equal to a level of an input signal exists at a pre-compensation lookup table;
when an input value equal to a level of an input signal does not exist at the pre-compensation lookup table, outputting a first input value and a second input value being approximate values of the input signal, a first distortion value corresponding to the first input value, and a second distortion value corresponding to the second input value;
generating a pre-distortion function connecting a first coordinate point formed of the first input value and the first distortion value and a second coordinate point formed of the second input value and the second distortion value; and
calculating a pre-distortion value corresponding to a level of the input signal on the pre-distortion function.

11. The digital pre-distortion method of claim 10, further comprising:
providing a distortion value corresponding to the input value as the pre-distortion value when an input value equal to a level of an input signal exists at the pre-compensation lookup table.

12. The digital pre-distortion method of claim 10, further comprising:
sampling and quantizing the input signal to provide a resultant value as a level of the input signal.

13. The digital pre-distortion method of claim 10, wherein the first input value is smaller than a level of the input signal and the second input value is an input value of the pre-compensation lookup table larger than the second input value.

14. The digital pre-distortion method of claim 10, further comprising:
feeding back an output of a power amplifier on the pre-distortion value;
comparing the fed-back pre-distortion value with the pre-distortion value; and
updating the pre-compensation lookup table based on a comparison result.

15. The digital pre-distortion method of claim 10, wherein the pre-distortion function is generated in light of non-linearity of a power amplifier in addition.
